(19) United States
(12) Patent Application Publication
(10) Pub. No.: US 2003/0171968 A1
(43) Pub. Date: Sep. 11, 2003

(54) Method for intermediacy

(75) Inventors: Tsuyoshi Yamada, Tokyo (JP); Toshio Nakano, Tokyo (JP); Yasushi Koseko, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 10/229,078

(22) Filed: Aug. 28, 2002

(30) Foreign Application Priority Data
Mar. 11, 2002 (JP) 2002-065529

(51) Int. Cl. G06F 17/60

(52) U.S. Cl. 705/8; 702/183

(57) ABSTRACT

Intermediacy between a company outsourcing semiconductor device testing, and a outsource company conducting the semiconductor device testing is accomplished by prompting the outsourcing company to input conditions required for the semiconductor testing, registering the inputted conditions, selecting an outsource company based on the conditions from among a plurality of outsource companies conducting semiconductor device testing, and presenting a list indicating the selected outsource company and its conditions to the outsourcing company.

### BACKGROUND OF THE INVENTION

1. Field of the Invention

The present invention relates to a method for intermediacy and in particular to a method for intermediating between a company outsourcing testing of semiconductor devices or electric apparatuses and an outsource company conducting the testing.

2. Background Art

In manufacturing semiconductor devices, for example, a wide variety of tests are conducted in various processes, such as a test of a junction in a fabricated semiconductor device. To conduct such tests, a manufacturer must provide specialized test equipment (hardware), programs (software) for causing the test equipment to operate to test the properties of individual semiconductor devices, DUT boards onto which the semiconductor devices to be tested are electrically connected, wafer probe cards, and other jigs according to the category of the semiconductor devices and tests.

Testing specifications, which are wide-ranging requirements for testing a semiconductor device, include, for example, technical conditions, such as the number of signal pins, operating frequency, operating power of the semiconductor device and the range of a test programs, which depend on the category of the semiconductor device and testing to be conducted, and business conditions such as a desired delivery date and price.

A semiconductor manufacturer may outsource these tests of semiconductor devices to an outside fabrication contractor, a so-called outsource fabricator. In such a case, the semiconductor manufacturer or a outside fab-less manufacturer that does not have its own production line must find and determine an outsource fabricator having test equipment, programs, and jigs that meet the test specifications for semiconductor device testing to be outsourced.

To choose an outsource fabricator to which the semiconductor device testing is to be outsourced, the semiconductor manufacturer first uses information available from various sources such as the Internet to find an outsource fabricator. Then, it obtains information about conditions such as test equipment installed in the outsource fabricator, the range of available programs, possible lead-time and price provided by the outsource fabricator, through business meetings with the outsource fabricator and determines whether it outsources the semiconductor device testing to the outsource fabricator based on the information. If a number of outsource fabricators to which the testing can be outsourced are found, the best suited outsource fabricator is chosen according to specifications for testing to be outsourced.

The chosen fabricator does not necessarily have conditions satisfying all the specifications, including equipment conditions. For example, even if both of the semiconductor manufacturer and the outsource fabricator fabricates and share semiconductor devices of the same model, different options may often be added to the devices and equipment used in testing is sometimes not exactly the same. Therefore, it is often the case that adequate testing cannot be conducted by the chosen outsource fabricator alone.

If adequate testing cannot be conducted by the chosen outsource fabricator alone, measures should be added in order to meet conditions that cannot be satisfied by the outsource fabricator. For example, if it use test equipment model different from that used in the outsourcing manufacturer, a test program must be converted for causing semiconductor test equipment to operate properly, DUT boards, wafer probe cards, or other jigs for the test equipment must be provided, or other measures must be taken. In such a case, another contractor must be chosen to outsource the conversion of the program or the manufacture of the jigs, in addition to the outsource fabricator.

As described above, it takes a lot of time and effort to choose an outsource fabricator to which semiconductor device testing is to be outsourced.

Semiconductor manufacturers often outsource semiconductor device testing to outsource fabricators if the testing is beyond their capacity in terms of functionality or production capacity of their equipment. In this case, many semiconductor manufacturers are required to complete the production of semiconductor devices in one or two months. Therefore, they manufacturers must choose as soon as possible outsource fabricators to which they outsource testing. However, the above-described way of choosing requires a lot of time and effort, hindering the quick decision-making. This may lead to delays in completion of semiconductor device production. As a result, the semiconductor device manufacturer outsourcing the testing as well as a customer company placing the order for the semiconductor devices with the semiconductor device manufacturer can miss business opportunities.

### SUMMARY OF THE INVENTION

In order to reduce time and effort required for choosing an outsource fabricator to which testing above is outsourced as described above, the present invention proposes a method and system for intermediating between a company outsourcing the testing and a outsource fabricator to which the testing is outsourced.

According to one aspect of the present invention, in a method for connecting a terminal of a company outsourcing semiconductor device testing with a terminal of an outsource company the conducting semiconductor device testing over a network to intermediate the semiconductor device testing, conditions required for the semiconductor device testing that are inputted from the terminal of the outsourcing company are registered. At least one outsource company is selected, based on the registered conditions, from among a plurality of outsource companies of which conditions are inputted from the terminal of the outsource companies and/or a data registration section in which the conditions are registered. An outsource company selection list indicating the outsource company selected at the outsource company selecting step and the conditions of the outsource company are presented to the outsourcing company.

According to another aspect of the present invention, in a method for connecting a terminal of a company outsourcing semiconductor device testing with a terminal of an outsource company conducting the semiconductor device testing over a network to intermediate the semiconductor device testing, conditions of equipment provided in the outsource company are registered, the conditions required for testing the semiconductor device being inputted from the outsource company. The conditions of the equipment are posted.

According to another aspect of the present invention, in a method for connecting a terminal of a company outsourcing electric apparatus testing with a terminal of an outsource company conducting the electric apparatus testing over a network to intermediate the electric apparatus testing, conditions required for the electric apparatus testing that are inputted from the terminal of the outsourcing company are registered. At least one outsource company is selected, based on the registered conditions, from among a plurality of outsource companies of which conditions are inputted from the terminal of the outsource companies and/or a data registration section in which the conditions are registered. An outsource company selection list indicating the outsource company selected at the step of outsource company selecting step and the conditions of the outsource company are presented to the outsourcing company.

Accordingly, time and effort required for the outsourcing company by itself to evaluate a plurality of outsource companies one by one to choose an outsource company can be reduced

Other and further objects, features and advantages of the invention will appear more fully from the following description.

### BRIEF DESCRIPTION OF THE DRAWINGS

FIG. 1 shows a schematic diagram showing connection of the outsource fabrication consultant 100 with the semiconductor manufacturer 2, according to the First Embodiment;

FIG. 2 is a schematic diagram showing connection of the outsource fabrication consultant 100 with the outsource fabricator 20, a program conversion company 30, a jig developer 36, and a semiconductor manufacturer 2 over the Internet 6:

FIG. 3 shows a schematic diagram of an input screen 40 for inputting specifications for testing outsourced by the semiconductor manufacturer 2;

FIG. 4 shows a schematic diagram of an output screen 50 on which information about a selected outsource fabricator 20, such as the outsource fabricator 20, is listed;

FIG. 5 shows a flow diagram for illustrating intermediacy between a semiconductor manufacturer 2 and an outsource fabricator 20 by the outsource fabrication consultant 100 configured as described above;

FIG. 6 shows a schematic diagram of an outsource company waiting list screen 60 displayed on the Web page of an outsource fabrication consultant 200 according to a Second Embodiment;

FIG. 7 shows a flow diagram for illustrating a process performed by the outsource fabrication consultant 200 for intermediating between a semiconductor manufacturer 2 and an outsource fabricator 20 according to the Second Embodiment;

FIG. 8 shows a flow diagram for illustrating intermediacy between a semiconductor manufacturer 2 and an outsource fabricator 20 by an outsource fabrication consultant 100;

FIG. 9 shows a flow diagram for illustrating a process in which an outsource fabrication consultant 100 intermediates between a semiconductor manufacturer 2 and an outsource fabricator 20 according to the Fourth Embodiment.

### DETAILED DESCRIPTION OF THE PREFERRED EMBODIMENTS

Embodiments of the present invention will be described below with reference to the accompanying drawings. In the drawings, like or equivalent elements are labeled with like numbers and the description of duplicated elements will be simplified or omitted.

First Embodiment

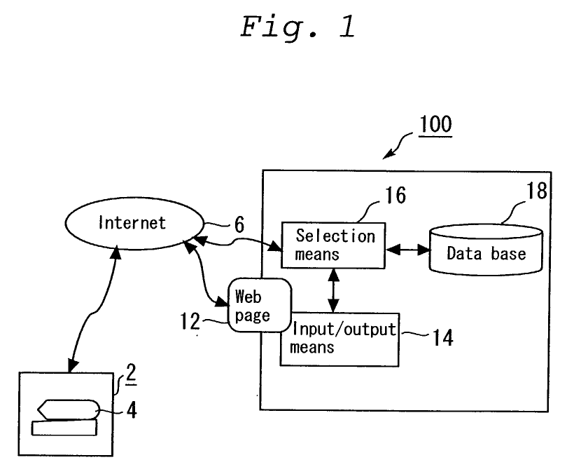

FIG. 1 shows a schematic diagram showing connection of the outsource fabrication consultant 100 with the semiconductor manufacturer 2, according to the First Embodiment.

In FIG. 1, a semiconductor manufacturer 2 is a company that outsources testing of semiconductor devices. A terminal 4 is provided at the site of the semiconductor manufacturer 2. The semiconductor manufacturer 2 is connected to the Internet 6 through the terminal 4.

An outsource fabrication consultant 100 is an intermediary agent between the semiconductor manufacturer 2 outsourcing the semiconductor device testing and an outsource fabricator 20 conducting the tests. The outsource fabrication consultant 100 has a Web page 12 and input means 14 for providing the Web page 12. The input means 14 is connected to selection means 16, which is connected to a database 18. The outsource fabrication consultant 100 is connected to the Internet 6 through the input means 14 and selection means 16.

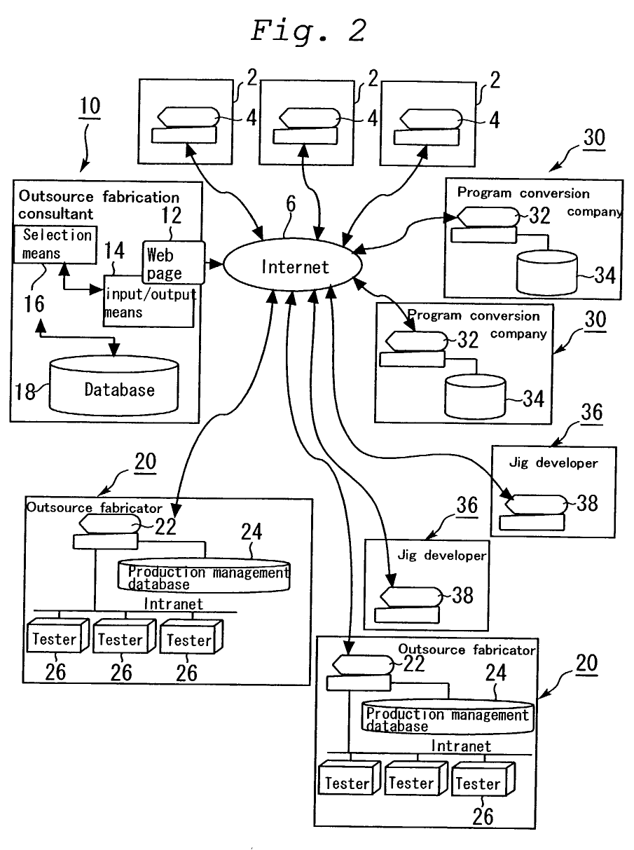

FIG. 2 is a schematic diagram showing connection of the outsource fabrication consultant 100 with the outsource fabricator 20, a program conversion company 30, a jig developer 36, and a semiconductor manufacturer 2 over the Internet 6.

The outsource fabricator 20 in FIG. 2 is a fabrication contractor that conducts tests of semiconductor devices. An input/output terminal 22 is provided at the site of the outsource fabricator 20. A plurality of testers 26 and a production management database 24 are connected to the terminal 22 over an intranet. The outsource fabricator 20 is connected to the Internet 6 through the terminal 22.

An input/output terminal 32 is provided at the site of the program conversion company 30. A production management database 34 is connected to the terminal 32. The program conversion company 30 is connected to the Internet 6 through the terminal 32.

An input/output terminal 38 is provided at the site of the jig developer 36. The jig developer 36 is connected to the Internet 6 through the terminal 38.

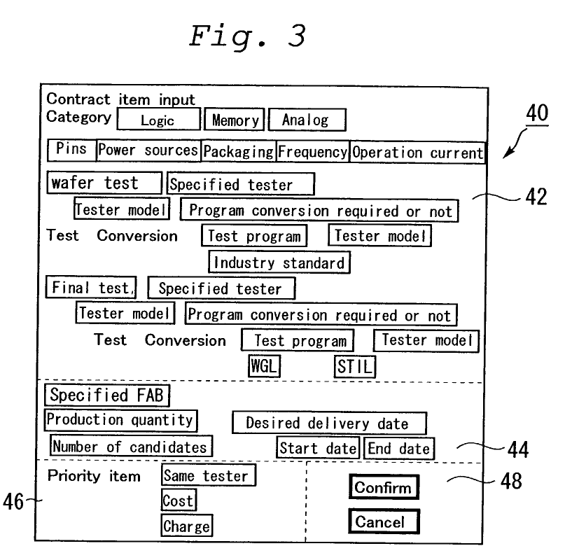

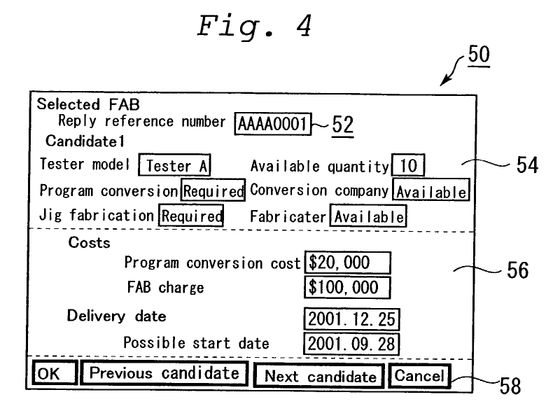

FIG. 3 shows a schematic diagram of an input screen 40 for inputting specifications for testing outsourced by the semiconductor manufacturer 2. FIG. 4 shows a schematic diagram of an output screen 50 on which information about a selected outsource fabricator 20, such as the outsource fabricator 20, is listed.

The input screen 40 and output screen 50 shown in FIGS. 3 and 4 are provided on the Web page 12.

The input screen 40 is used for inputting specifications for testing outsourced by the semiconductor manufacturer 2, as shown in FIG. 3. Provided on the input screen 40 are a technical condition input section 42, business condition input section 44, priority item input section 46, and confirmation button section 48.

Technical conditions can be inputted in the technical condition input section 42 by using a pull-down menu or keyboard, such as technical conditions for test equipment, including the category of a semiconductor device such as logic, memory, or analog, the number of signal pins of the semiconductor device, the number of power sources, package type, frequency, operating current, whether a tester is specified, and tester model, for example, which depend on the category of the semiconductor device to be tested and the category of the test.

Business conditions such as the number of semiconductor devices to be tested and a desired delivery date can be inputted in the business condition input section 44 by using a pull-down menu or the keyboard.

Conditions to which the semiconductor manufacturer 2 gives priority in choosing an outsource fabricator 20 can be inputted in the priority item input section 46 by using a pull-down menu or the keyboard.

A confirmation button and a cancel button are provided in the confirmation button section 48. After the completion of the input of the test specifications, the confirmation button is clicked to request the outsource fabrication consultant 100 to select an outsource fabricator satisfying the inputted conditions. On the other hand, to cancel inputted test specifications and end the selection of an outsource fabricator, the cancel button is clicked.

Provided on the output screen 50 are a reply reference number display section 52, an outside fabricator technical condition display section 54, a cost and delivery date display section 56, and a confirmation button section 58 as shown in FIG. 4. This output screen 50 presents information about an outsource fabricator 20 selected based on the conditions specified by the semiconductor manufacturer 2.

The reference number of a reply concerning the specifications for the test outsourced is displayed in the reply reference number display section 52. If the manufacturer 2 chooses the outsource fabricator 20 displayed on the output screen, the reference number will subsequently be used to manage the information about the fabricator 20.

Information about equipment installed in the outsource fabricator 20, such as the model of testers, the number of the testers, whether program conversion is required, and whether the fabrication of a jig is required, is displayed on the outsource fabricator technical condition display section 54. In addition, whether any program conversion company is available is displayed if program conversion is required, and whether a jig manufacturer is available is displayed if the fabrication of a jig is required.

Approximate estimated costs, a possible delivery date, and a possible starting date are displayed in the cost and delivery data display section 56.

Provided in the confirmation button section 58 are an OK button for accepting the outsource fabricator currently displayed, the next and previous candidate buttons for viewing the next or previous candidate outsource fabricator, and a cancel button.

The semiconductor manufacturer 2 can access the input screen 40 and output screen 50 on the Web page 12 of the outsource fabrication consultant 100 configured as described above over the Internet 6 through the terminal 4. This allows the semiconductor manufacturer 2 to input and specify specifications for semiconductor device testing inputted in the input screen 40 of the Web page 12 and request the outsource fabrication consultant 100 to select an outsource fabricator 20 that meets the test specifications. The semiconductor manufacturer 2 can also access a list of outsource fabricators 20, which is provided on the output screen 50 of the Web page 12 as a result of the selection by the outsource fabrication consultant 100, to view and select an outsource fabricator 20 to which test is outsourced.

The outsource fabricator 20 can check the information about available testers 26 and register it in the production management database 24 through the terminal 22. The production management database 24 allows the outsource fabricator 20 to obtain the picture of its own equipment.

The program conversion company 30 and the jig developer 36 can check equipment and its conditions through the terminals 32 and 38, respectively. The information about the equipment and conditions checked can be sent through the terminals 22, 32 and 38, beforehand or as required, to the outsource fabrication consultant 100 over the Internet 6. The outsource fabricator 20, program conversion company 30, and jig developer 36 can use their respective terminals 22, 32, and 38 to receive a contract for testing, program conversion, or jig fabrication from the outsource fabrication consultant 100 over the Internet 6.

The input/output means 14 of the outsource fabrication consultant 100 can read test specifications inputted in the input screen 40 of the Web page 12 from the semiconductor manufacturer 2 and output information about a selected outsource fabricator 20 onto the output screen 50.

The selection means 16 can select an outsource fabricator 20 in the database 18 based on the test specifications read by the input/output means 14. In addition, it can obtain the status of an external outsource fabricator 20 over the Internet 6 as required. Based on this information, the selection means 16 also selects outsource fabricators 20 that are best meet conditions specified by the semiconductor manufacture 2 according to the priority of the conditions in the test specifications specified by the semiconductor manufacturer 2. The selection means 16 reports the selected outsource fabricators 20 and their conditions to the input/output means 14 in descending order of specification satisfaction level.

Semiconductor testing requires, in addition to test equipment, a program for causing the test equipment to operate appropriately. Different programs for different pieces of semiconductor test equipment are written in different languages and syntaxes and different test specifications are used for different types of semiconductor device. Therefore, a program for each type of semiconductor device is required to be provided. The outsource fabrication consultant 100 can store information about program conversion companies 30 in the database 18 and connect to the program conversion companies 30 over the Internet 6. This allows the selection means 16 to select a program conversion company 30 with which an order for conversion of a program is to be placed, if necessary.

Furthermore, semiconductor device testing requires, besides the test equipment, a DUP board for electrically connecting a semiconductor device to the test equipment, a probe card, and other jigs. These jigs and other elements must be provided for each type of semiconductor device. The outsource fabrication consultant 100 can store information about jig developers 36 fabricating such jigs and connect to the jig developers 36 over the Internet 6. This allows the selection means 16 to select a jig developer 36 with which an order for making jigs is to be placed, if necessary.

The outsource fabrication consultant 100 is run on charges paid when semiconductor manufacturers 2 use the outsource fabrication consultant 100 to select outsource fabricators 20 to which testing is outsourced and charges for registering information about program conversion companies 30 and jig developers 36 in the database 18.

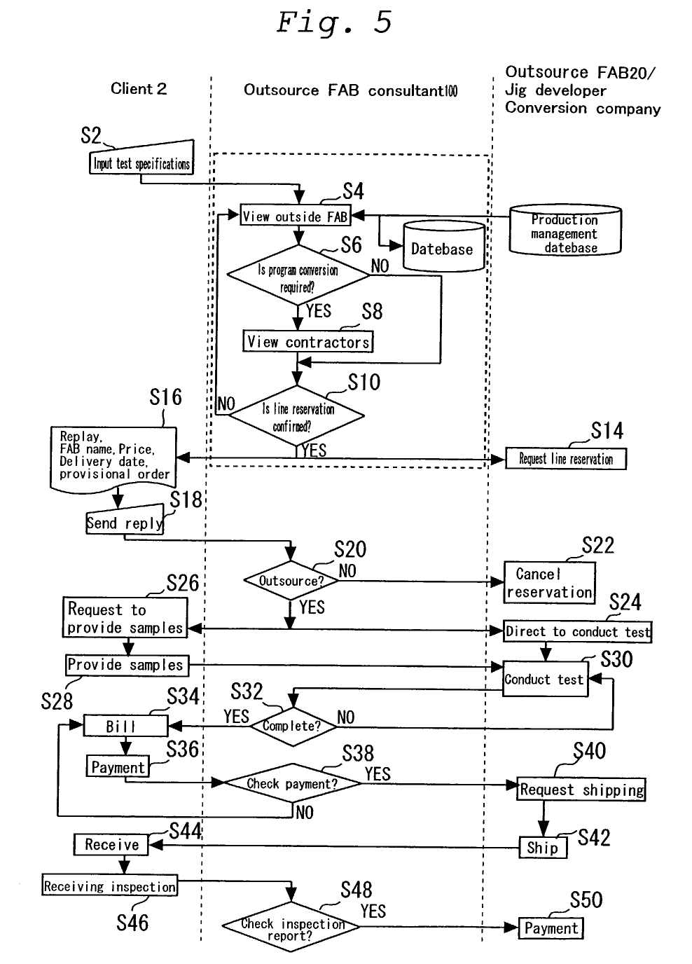

FIG. 5 shows a flow diagram for illustrating intermediacy between a semiconductor manufacturer 2 and an outsource fabricator 20 by the outsource fabrication consultant 100 configured as described above.

An example will be described in which the semiconductor manufacturer 2 uses the outsource fabrication consultant 100 to choose an outsource fabricator 20 to outsource semiconductor device testing to it.

First, the semiconductor manufacturer 2 connects to the Internet 6 through the terminal 4 to access the input screen 40 of the Web page 12 of the outsource fabrication consultant 100. An operator at the semiconductor manufacturer 2 inputs requirements such as the category of semiconductor devices to be tested, the category of testing to be outsourced and a desired delivery date in the technical condition input section 42 and business condition input section 44 on the input screen 40 through the terminal 4 to provide test specifications. The operator also inputs a high priority condition among the conditions in the priority item input section 46. Then the operator clicks the confirmation button 48 to confirm and register the specifications for testing to be outsourced. In this way, the semiconductor manufacturer 2 requests the outsource fabrication consultant 100 to select outsource fabricators 20 (step S2).

The outsource fabrication consultant 100 reads the test specifications registered by the semiconductor manufacturer 2 from the input screen 40 of the Web page 12 through the input/output means 14. The read specifications are provided to the selection means 16. The selection means 16 selects an outsource fabricator 20 based on information in the database 18 according to the specifications. It also obtains and investigates information such as conditions of the outsource fabricator 20 over the Internet 6, if necessary (step S4).

Then, the selection means 16 compares conditions of the selected outsource fabricator 20, such as equipment, with the specifications provided by the semiconductor manufacturer 2 to determine whether program conversion is required or not and whether jigs are required or not (step S6). If program conversion and/or jigs are required, it chooses a program conversion company 30 and/or a jig developer 36 based on information in the database 18 (step S8).

Then, the outsource fabrication consultant 100 provides an inquiry to the terminals 22, 32, 38 of the selected outsource fabricator 20, program conversion company 30, and jig developer 36 as to whether a line can provisionally be reserved (step S10). If no line can be reserved, it searches for another outsource fabricator 20 (step S4 through S10).

If provisional reservation of a line is possible, the outsource fabrication consultant 100 sends a request for the provisional reservation to the terminals 22, 32, 38 of the selected outsource fabricator 20, the program conversion company 30 and jig developer 36 over the Internet 6 (step S14). At the same time, the outsource fabrication consultant 100 provides a list indicating the selected outsource fabricator 20, program conversion company 30, and jig developer 36 and information such as their conditions to the semiconductor manufacturer 2 through the input/output means 14 (step S16).

The operator at the semiconductor manufacturer 2 views the list provided on the output screen 50 and sends a reply indicating whether the semiconductor manufacturer 2 outsources the semiconductor device testing to the listed outsource fabricator 20, program conversion company 30, and/or jig developer 36 (step S18). If the semiconductor manufacturer 2 outsources the testing to the listed outsource fabricator 20, program conversion company 30, and/or jig developer 36, the operator accesses the output screen 50 of the Web page 12 from the terminal 4 and clicks the OK button in the confirmation button section 58. If the semiconductor manufacturer 2 does not outsource the testing to the listed outsource fabricator 20, program conversion company 30, and/or jig developer 36, the operator clicks the next candidate button through the terminal 4 and examines an outsource fabricator 20 listed as the next candidate. If the semiconductor manufacturer 2 does not outsource the testing to any of the selected outsources, the operator clicks the cancel button.

The outsource fabrication consultant 100 reads the reply from the semiconductor fabricator 2 through the input/output means 14 and determines whether the reply indicates outsourcing to the selected outsource fabricator 20, program conversion company 30, and/or jig developer 36 or cancellation (step S20).

If the reply from the semiconductor manufacturer 2 indicates cancellation of outsourcing to the selected outsource fabricator 20, program conversion company 30, and/or jig developer 36, the outsource fabrication consultant 100 reports the cancellation of the line reservation to the terminal 22, 34, 38 of the outsource fabricator 20, program conversion company 30, and/or jig developer 36 over the Internet 6 (step S22). On the other hand, if the replay indicates that the semiconductor manufacturer 2 has decided to outsource the testing to the selected outsource fabricator 20, program conversion company 30, and/or jig developer 36, the outsource fabrication consultant 100 sends a request for conducting the testing to the terminal of the selected outsource fabricator 20, program conversion company 30, and/or jig developer 36 (step S24). If necessary, it sends a request for providing samples and data to the terminal of the semiconductor manufacturer 2 (step S26). The semiconductor manufacturer 2 receives the request and provides the requested data and samples to the outsource fabricator 20, program conversion company 30, and/or jig developer 36 (step S28).

The selected outsource fabricator 20, program conversion company 30, and/or jig developer 36 receive the data and samples and, when it becomes ready to conduct the testing, conducts the testing of the semiconductor devices based on the test specification provided. After the completion of the testing, it reports the completion to the outsource fabrication consultant 100 (step S30).

The outsource fabrication consultant 100 reconfirms the completion of the test (step S32). If the test has not been completed, the outsource fabrication consultant 100 urges the outsource fabricator 20 to conduct the test. If the test has been completed, it requests the payment of test charges from the semiconductor manufacturer 2 (step S34).

The semiconductor manufacturer 2 pays the charges to the outsource fabrication consultant 100 based on payment terms (step S36).

The outsource fabrication consultant 100 checks the amount of the payment (step S38) and, if the payment is incomplete, requests again the payment from the semiconductor manufacturer 2. On the other hand, if the outsource fabrication consultant determines that the payment has been completed, it requests the outsource fabricator 20 to ship the tested semiconductor devices (step S40).

The outsource fabricator 20 ships the tested semiconductor devices to the semiconductor manufacturer 2 (step S42). The semiconductor manufacturer 2 receives them (step S44), performs a receiving inspection to determine whether the testing is conducted as specified (step S46), then reports the results of the inspection to the outsource fabrication consultant 100.

The outsource fabrication consultant 100 checks the inspection report from the semiconductor manufacturer 2 (step S48). If the outsource fabrication consultant 100 determines that the testing has been conducted as specified, it pays the charges to the outsource fabricator 20 (step S50).

The outsource fabricator 20 receives the charge paid, then the test outsourcing process by this intermediary system ends.

As described above, the outsource fabrication consultant 100 can be used to select an outsource fabricator 20 to which semiconductor testing is outsourced.

According to this embodiment, all information about the outsource fabricators 20 can be centralized at the outsource fabrication consultant 100. Therefore, the semiconductor manufacturer 2 itself does not need to investigate a number of outsource fabricators one by one before it outsources testing of semiconductor devices. As a result, time and effort required for choosing an outsource fabricator to which the testing is to be outsourced can be minimized and, as a result, late deliveries of semiconductor devices can be avoided.

An outsource fabricator 20 can be selected from among all outsource fabricators 20 registered in the outsource fabrication consultant 100. Therefore, the semiconductor manufacturer 2 can choose an outsource fabricator 20 that is more advantageous to it in terms of costs and delivery dates based on a larger amount of information about outsource fabricators 20.

The selection means 16 provided at the outsource fabrication consultant 100 allows various outsource fabricators 20 to be compared with one another in terms of a wide variety of conditions at a time. Therefore, the best suited outsource fabricator 20 can be chosen quickly and properly.

According to this embodiment, if an outsource fabricator 20 alone cannot satisfy test specifications, the outsource fabrication consultant 100 selects a program conversion company 30 and/or jig developer 36 in order to satisfy requirements that cannot be satisfied by the outsource fabricator 20. Therefore, the semiconductor manufacturer 2 does not need to search for a program conversion company 30 and/or jig developer 36 by itself. As a result, time and effort required for choosing outsource companies can be reduced and, as a result, delay in completion of semiconductor device production can be prevented.

According to this embodiment, the outsource fabrication consultant 100 receives charges in trust after the completion of testing of semiconductor devices but before the delivery of them, and pays the charge to the outsource fabricator 20 after the consultant 100 confirms the completion of the testing. Therefore, trouble about payment can be avoided even though the testing is outsourced over the Internet 6.

While the embodiment has been described with respect to an intermediary service for outsourcing a semiconductor device test process, the present invention is not limited to the test process. The intermediary service by the outsource fabrication consultant 100 can be used for outsourcing any manufacturing processes, such as design, assembly, and wafer processes. The present invention is not limited to testing of semiconductor devices. The intermediary service by the outsource fabrication consultant 100 can be used for outsourcing testing of electric apparatuses, for example.

The intermediary system and method have been described with respect to the embodiment in which the input/output means 14 of the outsource fabrication consultant 100 is connected to the terminals 4, 22, 32, and 38 of the outsourcing company and outsourced companies over the Internet 6 and outsourcing of testing is intermediated over the Internet 6. However, the present invention is not limited to the Internet 6. Any other communication means may be used for the intermediacy.

The embodiment has been described in which program conversion companies 30 and/or jig developers 36 are selected and listed if an outsource fabricator 20 alone cannot satisfy test specifications. Companies to be selected are not limited to program conversion companies 30 and jig developers 36. Companies of other categories can be listed that satisfy requirements that cannot be satisfied by the outsource fabricator 20. Alternatively, means for listing such companies may be omitted and outsource fabricators 20 may be selected and listed alone.

The embodiment has been described in which the outsource fabrication consultant 100 receives charges beforehand and pays the charges to the outsource fabricator 20 after the outsource fabricator 20 delivers tested semiconductor devices. This system is used for security reasons because the intermediary services are provided over the Internet 6. The present invention is not limited to this charge payment system.

The embodiment has been described in which the outsource fabrication consultant 100 has the Web page 12 and test specifications are entered and the list is presented through the Web page 12. However, other means may be used for registering the test specifications and presenting the lists.

While the embodiment has been described with respect to the input screen 40 and output screen 50 provided on the Web page 12, any other means may be used in place of the input screen 40 and output screen 50 through which specifications specifying conditions of testing can be inputted and outsource fabricators that satisfying the conditions can be presented.

The embodiment has been described in which the semiconductor manufacturer outsourcing the testing has terminal 4, and the outsource fabricator 20, program conversion company 30, and the jig developer 36 have terminals, 22, 32, and 38, respectively. These terminals are used as means for communicating with the outsource fabrication consultant 100 over the Internet 6. However, in the present invention, the communication means is not limited to terminals.

Second Embodiment

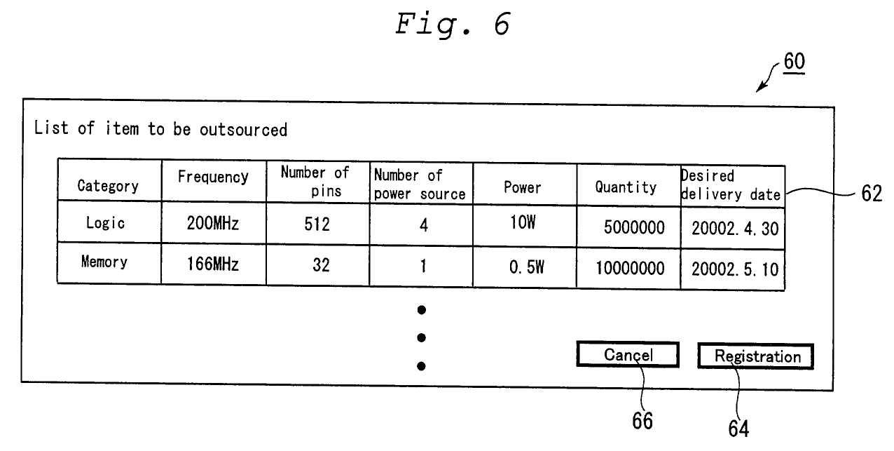

FIG. 6 shows a schematic diagram of an outsource company waiting list screen 60 displayed on the Web page of an outsource fabrication consultant 200 according to a Second Embodiment.

The outsource fabrication consultant 200 has the outsource company waiting list screen 60 in addition to an input screen 40 and output screen 50 provided on its Web page 12.

The outsource company waiting list screen 60 is displayed on the Web page 12 if a semiconductor manufacturer 2 cannot immediately choose an outsource fabricator that meets conditions specified by the semiconductor manufacturer 2.

The outsource company waiting list screen 60 contains a outsource waiting item list display section 62, a registration button 64, and a cancel button 66.

Displayed on the outsource waiting item list display section 62 are test specifications specified by the semiconductor manufacturer 2, such as the category, frequency, number of pins, number of power sources, electric power, quantity, and delivery date of semiconductor devices.

The outsource fabricator 20 can access the outsource company waiting list screen 60 over the Internet 6. If the outsource fabricator 20 can conduct testing of devices contained in the outsource waiting item list section 62, an operator at the outsource fabricator 20 clicks the registration button 64 to communicate to the outsource fabrication consultant 200. This allows the outsource fabrication consultant 200 to evaluate and select the outsource fabricator 20 as a candidate to which the testing is outsourced.

If the outsource fabricator 20 cannot conduct the testing of the devices contained in the outsource waiting item list section 62, the operator clicks the cancel button 66 to end the process.

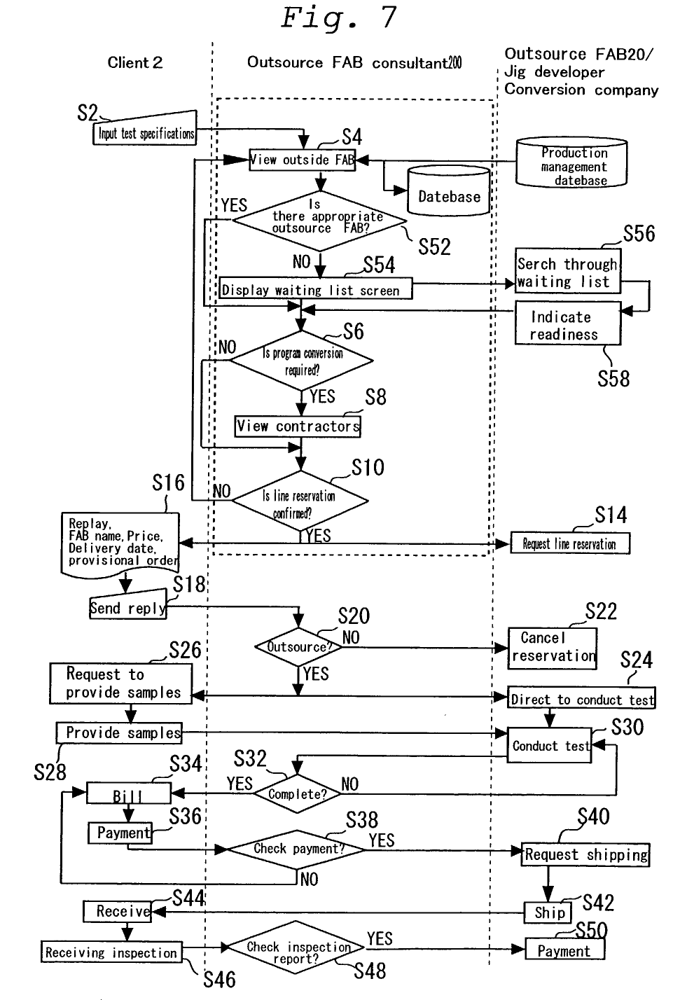

FIG. 7 shows a flow diagram for illustrating a process performed by the outsource fabrication consultant 200 for intermediating between a semiconductor manufacturer 2 and an outsource fabricator 20 according to the Second Embodiment.

Referring FIG. 7, a process will be described below in which the semiconductor manufacturer 2 uses the outsource fabrication consultant 200 to choose an outsource fabricator 20 to outsource semiconductor device testing to it.

First, the semiconductor manufacturer 2 inputs and registers specifications for the testing to be outsourced on the input screen 40 (step S2).

The outsource fabrication consultant 200 assesses outsource fabricators 20 based on the registered specifications for testing (step S4).

Then, the outsource fabrication consultant 200 determines whether there is an outsource fabricator 20 that meets the conditions (step S52).

If the outsource fabrication consultant 200 cannot immediately select a outsource fabricator 20 that meets the conditions, it displays the test specifications on the outsource company waiting list screen 60 of the Web page 12 (step S54).

An outsource fabricator 20 accesses the outsource company waiting list screen 60 over the Internet 6 (step S56). The outsource fabricator 20 views the specifications for testing displayed on the outsource company waiting list screen 60 and, if it can conduct the testing, an operator at the outsource fabricator 20 clicks the registration button 62 to indicate that it can contract the testing outsourced (step S58).

Then the process proceeds to a step at which conditions of equipment installed at the outsource fabricator 20 are compared with the testing specifications provided by the semiconductor manufacturer 2 to determine whether program conversion and/or jig fabrication is required (step S8). The subsequent steps are the same as those in the First Embodiment and therefore the description of which will be omitted.

According to the Second Embodiment, the possibility is left open that the testing is completed by a due date specified by the semiconductor manufacturer 2 even if it cannot immediately choose an outsource fabricator 20. In addition, the outsource fabricator 20 can advantageously access to the outsource company waiting list screen 60 to seize business opportunities to contract testing that it can conduct.

The Second Embodiment has been described by using the example in which the waiting screen 60 is displayed if a semiconductor manufacturer 2 cannot immediately choose an outsource fabricator 20 that can conduct testing according to its specifications. The present invention is not limited to this example. A similar list of required conversions or jigs may also be displayed if the semiconductor manufacturer 2 cannot immediately choose a program conversion company 30 or jig developer 36.

While the Second Embodiment has been described with respect to an intermediary service for outsourcing a semiconductor device test process, the present invention is not limited to the test process. The intermediary service by the outsource fabrication consultant 200 can be used for outsourcing any manufacturing processes, such as design, assembly, and wafer processes. The present invention is not limited to testing of semiconductor devices. The intermediary service by the outsource fabrication consultant 200 can be used for outsourcing testing of electric apparatuses, for example.

Third Embodiment

Configuration of an outsource fabrication consultant in a Third Embodiment is the same as that of the outsource fabrication consultant 100. However, a intermediacy method according to the Third Embodiment differs from the method according to the First Embodiment in that if an outsource fabricator 20 capable of conducting testing conforming to specifications cannot immediately be selected because all of its equipment is occupied, the outsource fabricator 20 can be informed that its availability is waited for.

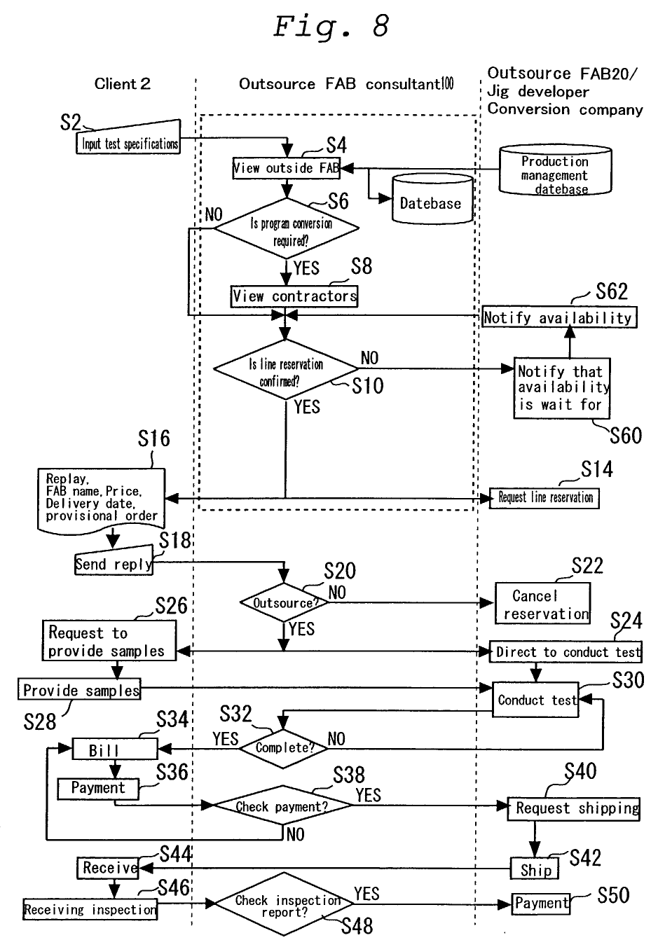

FIG. 8 shows a flow diagram for illustrating intermediacy between a semiconductor manufacturer 2 and an outsource fabricator 20 by an outsource fabrication consultant 100.

Referring FIG. 8, a process will be described in which the semiconductor manufacturer 2 uses the outsource fabrication consultant 100 to choose an outsource fabricator 20 to outsource semiconductor device testing to it.

First, the semiconductor manufacturer 2 inputs and registers specifications for the testing to be outsourced on the input screen 40 (step S2).

The outsource fabrication consultant 100 assesses outsource fabricators 20 based on the registered specifications for testing (step S4).

Then, the outsource fabrication consultant 100 determines whether program conversion and/or fabrication of jigs is required (step S6). If program conversion and/or fabrication of jigs is required, it chooses a program conversion company 30 and/or a jig developer 36 based on information in the database 18 (step S8).

Then, the outsource fabrication consultant 100 inquires of the selected outsource fabricator 20, program conversion company 30, and jig developer 36 whether a line can provisionally be reserved over the Internet 6 through input/output means 14 (step S10).

If the line cannot be reserved, the outsource fabrication consultant 100 informs over the Internet 6 through input/output means 14 the outsource fabricator 20, program conversion company 30, or jig developer 36 of which no line cannot be reserved that its availability is waited for (step S60).

When the outsource fabricator 20, program conversion company 30, or jig developer 36, informed that is on the waiting, becomes available for testing, conversion, or fabrication, it notifies the outsource fabrication consultant 100 of it (step S62).

The outsource fabrication consultant 100 receives the notification, re-inquires whether the line can be reserved (step S10), then requests the provisional reservation of the line from the outsource fabricator 20, program conversion company 30, or jig developer 36 (step S14). At the same time, it provides a list containing information about the selected outsource fabricator 20, program conversion company 30, or jig developer 36, and their conditions (step S16). The remaining part of the process is the same as that in the First Embodiment and therefore the description of which will be omitted.

According to the Third Embodiment, the possibility is left open that the testing may be completed by a due date specified by the semiconductor manufacturer 2 even if all equipment of the selected outsource fabricator 20 is occupied. In addition, the outsource fabricator 20 is advantageously informed that its availability is waited for and, as a result, can seize business opportunities to contract testing that it can conduct.

While the Third Embodiment has been described with respect to an intermediary service for outsourcing a semiconductor device test process, the present invention is not limited to the test process. The intermediary service by the outsource fabrication consultant 100 can be used for outsourcing any manufacturing process, such as design, assembly, and wafer processes. The present invention is not limited to testing of semiconductor devices. The intermediary service by the outsource fabrication consultant 100 can be used for outsourcing testing of electric apparatuses, for example.

Fourth Embodiment

According to a Fourth Embodiment, an semiconductor manufacturer 2 can search for data about outsource fabricators 20, program conversion companies 30, and jig developers 36 registered with an outsource fabrication consultant 100 over the Internet 6 without registering specifications for testing.

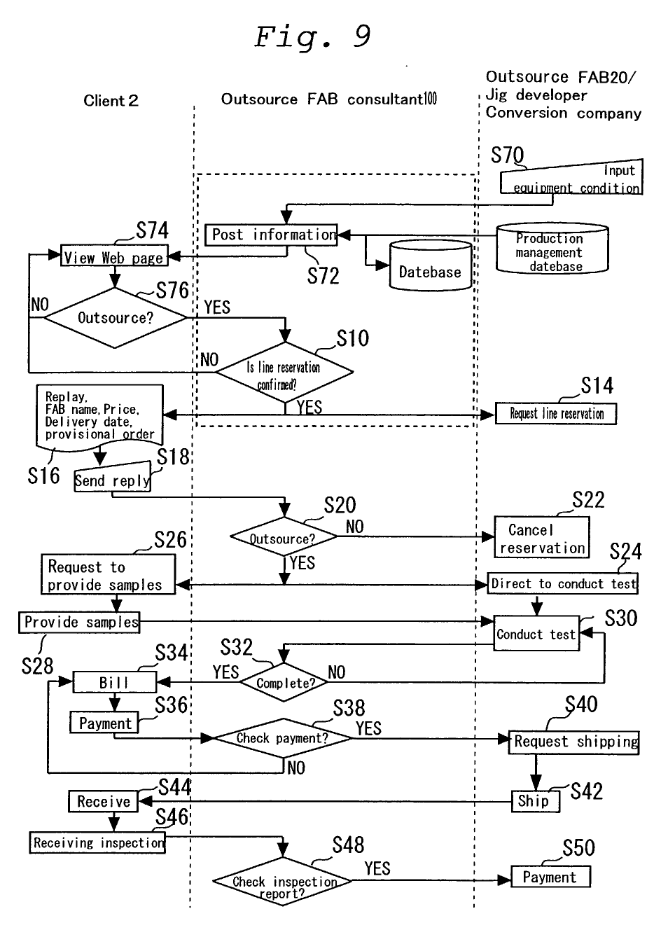

FIG. 9 shows a flow diagram for illustrating a process in which an outsource fabrication consultant 100 intermediates between a semiconductor manufacturer 2 and an outsource fabricator 20 according to the Fourth Embodiment.

First, a outsource fabricator 20, program conversion company 30, and jig developer 36 register their conditions in a database 18 of the outsource fabrication consultant 100 from their respective terminals 22, 32, and 38 over the Internet 6 (step S70).

The outsource fabrication consultant 100 reads conditions of the outsource fabricators 20 registered in the database 18 and provides them on its Web page 12 as a public list of outsource fabricator conditions to post the information on the public view (step S72).

A semiconductor manufacturer 2 accesses the outsource fabricator condition list through a terminal 4 over the Internet 6 and determines whether it outsources testing to an outsource fabricator 20 based on the conditions on the list 70 (step S74).

If the semiconductor manufacturer 2 outsources the testing, it informs the outsource fabrication consultant 100 that it wants to outsource the testing to the outsource fabricator 20 (step S76).

Then, the outsource fabrication consultant 100 inquires of the outsource fabricator 20 and, if necessary, a program conversion company 30 and/or a jig developer 36, whether a line can be provisionally be reserved (step S10). If the line can be reserved, the outsource fabrication consultant 100 requests the provisional reservation from the selected outsource fabricator 20, program conversion company 30, and jig developer 36 (step S14). At the same time, it provides a list information about the selected outsource fabricator 20, program conversion company 30, and jig developer 36 and their conditions to the semiconductor manufacturer 2 through an output screen 50 on the Web page 12 (step S16) to ask if it outsources the testing (step S18). The remaining part of the process is the same as that in the First Embodiment and therefore the description of which will be omitted.

According to the Fourth Embodiment, the outsourcing manufacturer, which is familiar with particular specifications can easily found an outsource fabricator 20 to which outsource. Therefore, it can choose the outsource fabricator 20 quickly and properly with minimum effort. In addition, because information about outsource fabricators 20 and other outsource companies is centralized at the outsource fabrication consultant 100, the outsourcing manufacturer 2 can choose the outsource fabricator 20 from among a larger number of outsource fabricators and therefore can make a more proper choice.

While the Fourth Embodiment has been described with respect to an intermediary service for outsourcing a semiconductor device test process, the present invention is not limited to the test process. The intermediary service by the outsource fabrication consultant 100 can be used for outsourcing any manufacturing process, such as design, assembly, and wafer processes. The present invention is not limited to testing of semiconductor devices. The intermediary service by the outsource fabrication consultant 100 can be used for outsourcing testing of electric apparatuses, for example.

In the present invention, an outsourcing company may be, for example, the semiconductor manufacturer 2 in the First through Fourth Embodiments. An outsourced company may be the outsource fabricator and a contractor may be the program conversion company 30 or jig developer 36. An intermediary agent may be the outsource fabrication consultants 100, 200, for example.

The step of registering conditions according to the present invention is accomplished by performing step S2 in the First through Third Embodiments of the present invention, for example. The step of selecting an outsource company is accomplished by performing steps S4 to S10 in the First Embodiment, steps S4, S52 to S58, S8, and S10 in the Second Embodiment, or steps S2 to S10, and S60 to S62 in the Third Embodiment, for example. The step of presenting a list is accomplished by performing the step S16 in the First through Third Embodiments, for example.

The selection and registration step of the present invention is accomplished by performing step S18 and the selection and notification step of the present invention is accomplished by performing steps S20 to S24 in the first through Third Embodiment, for example.

The step of registering equipment conditions according to the present invention is achieved by performing step S70 and the step of posting equipment conditions can be accomplished by performing step S72 in the Fourth Embodiment, for example:

A data registration module according to the present invention may be the database 18 in the First through Third Embodiments, for example. A selection list of the present invention may be the output screen 50 in the First through Third Embodiments and company waiting list may be the outsource company waiting screen 60 in the Second Embodiment, for example.

The features and the advantages of the present invention as described above may be summarized as follows.

According to one aspect of the present invention, outsourcing is intermediated between an outsourcing company that outsources semiconductor device testing and an outsource company that conducts the testing according to the present invention. Accordingly, time and effort required for the outsourcing company by itself to evaluate a plurality of outsource companies one by one to choose an outsource company can be reduced and therefore delay in completion of semiconductor device production can be prevented.

In another aspect, information about a plurality of outsource companies can be centralized at an intermediary agent. Accordingly, an outsource company can be properly selected based on a larger amount of information than the amount of information that the outsourcing company has. As a result, an outsource fabricator 20 that is more advantageous to the outsourcing company in terms of costs and delivery dates can be chosen.

In another aspect, the outsource company can register conditions of its equipment in a database of the intermediary agent to receive test outsourcing contract. Accordingly, it can use its equipment efficiently to carry out its business.

In another aspect, an outsource company waiting list may be presented if the outsourcing company cannot immediately chose an outsource company or contractor. Accordingly, the possibility is left open that the testing is completed by a due date specified by the outsourcing company. In addition, an outsource company and contractor can search the list for a test that it can conduct and therefore can seize business opportunities.

In another aspect, if the outsourcing company cannot immediately chose an outsource company or contractor, it may indicate that it waits for the availability of the outsource company or contractor. Accordingly, the possibility is left open that testing is completed by a due date specified by the outsourcing company even if all equipment of the outsource company is occupied. In addition, the outsource company or contractor can seize business opportunities to contract to conduct the testing when it becomes available.

In another aspect, an outsourcing company may be able to choose an additional contractor if an outsourced company alone cannot conduct testing that satisfies specifications provided by the outsourcing company. Accordingly, time and effort for choosing the contractor can be reduced and, as a result, delay in completion of semiconductor device production can be prevented In another aspect, information about the conditions of equipment installed in outsource companies may be posted on the public view so that an outsourcing company can search for an outsource company. Accordingly, the outsourcing company, which is familiar with particular specifications, can readily found an appropriate outsource company. As a result, it can choose the appropriate outsource company with minimum time and effort. In addition, because the information about the outsource companies is centralized at an intermediary agent, the outsourcing company can search through a list of larger number of outsource companies and therefore can make a more appropriate choice.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2002-065529, filed on Mar. 11, 2002 including specification, claims, drawings and summary, on which the Convention priority of the present application is based, are incorporated herein by reference in its entirety.

1. A method for connecting a terminal of a company outsourcing semiconductor device testing with a terminal of an outsource company the conducting semiconductor device testing over a network to intermediate the semiconductor device testing, comprising the steps of:
registering conditions required for said semiconductor device testing that are inputted from the terminal of said outsourcing company;
selecting, based on the conditions registered at said step of registering the conditions, at least one outsource company from among a plurality of outsource companies of which conditions are inputted from the terminal of said outsource companies and/or a data registration section in which the conditions are registered; and
presenting an outsource company selection list indicating said outsource company selected at said outsource company selecting step and the conditions of said outsource company to said outsourcing company.

2. The intermediating method according to claim 1, wherein said outsource company selecting step comprises the step of posting a company waiting list containing the conditions registered at said condition registering step if any outsourcing company satisfying the conditions registered at said condition registering step cannot be selected immediately.

3. The intermediating method according to claim 1, wherein said outsource company selecting step comprises the step of, if it is determined that an outsource company satisfying the conditions registered at said condition registering step is unavailable to be selected because all equipment of the outsource company is occupied, indicating to said outsource company that the availability of said outsource company is waited for.

4. The intermediating method according to claim 1, wherein said network is further connected to a terminal of a contractor having means satisfying some of the conditions required for said semiconductor device testing and said method comprising the step of:
if it is determined at said outsource company selecting step that said selected outsource company alone is insufficient for conducting testing satisfying said conditions,
selecting a contractor providing means for satisfying the required testing conditions registered at said condition registering steps from among a plurality of contractors about which data is inputted from a terminal of said plurality of contractors and/or a data registration section in which conditions of said plurality of contractors are registered; and
indicating said outsource company and the conditions of said outsource company as well as said selected contractor and the conditions of said selected contractor at said list presenting step.

5. The intermediating method according to claim 4, further comprising the step of, if it is determined at said outsource company selecting step that any outsource company and/or contractor that satisfies the conditions registered in the registering step cannot immediately be selected, a company waiting list containing the conditions registered at said condition registering step is posted.

6. The intermediating method according to claim 4, further comprising the step of, if it is determined at said company selecting step that the outsource company and/or contractor that satisfies the conditions registered at said condition registration step is unavailable to be selected because all equipment of the outsource company and/or contractor is occupied, indicating to said outsource company and/or contractor that the availability of said outsource company and/or contractor is waited for.

7. The intermediating method according to claim 1, further comprising the steps of: if said outsourcing company selects any of said outsource companies indicated on said outsource company selection list,
registering the selected outsource company selected through the terminal of said outsourcing company in registration means; and
indicating to the terminal of said selected outsource company that said outsource company is selected.

8. A method for connecting a terminal of a company outsourcing semiconductor device testing with a terminal of an outsource company conducting the semiconductor device testing over a network to intermediate the semiconductor device testing, comprising the steps of:
registering conditions of equipment provided in said outsource company, said conditions required for testing said semiconductor device being inputted from said outsource company; and
posting the conditions of the equipment.

9. A method for connecting a terminal of a company outsourcing electric apparatus testing with a terminal of an outsource company conducting the electric apparatus testing over a network to intermediate the electric apparatus testing, comprising the steps of:
registering conditions required for said electric apparatus testing that are inputted from the terminal of said outsourcing company;
selecting, based on the conditions registered at said step of registering the conditions, at least one outsource company from among a plurality of outsource companies of which conditions are inputted from the terminal of said outsource companies and/or a data registration section in which the conditions are registered; and
presenting an outsource company selection list indicating said outsource company selected at said step of outsource company selecting step and the conditions of said outsource company to said outsourcing company.
